(19) United States
(12) Patent Application Publication
(10) Pub. No.: US 2026/0359373 A1
(43) Pub. Date: Nov. 12, 2026

(54) LINK REDIRECT METHODS, DEVICE AND STORAGE MEDIUM

(71) Applicant: Beijing Zitiao Network Technology Co., Ltd., Beijing (CN)

(72) Inventors: Chao ZHANG, Beijing (CN); Yacheng MOU, Beijing (CN); Jiahao ZHANG, Beijing (CN); Yinzhu LIU, Beijing (CN)

(21) Appl. No.: 19/475,330

(22) PCT Filed: Apr. 9, 2024
(86) PCT No.: PCT/CN2024/086843

§ 371 Date: Oct. 14, 2025

(30) Foreign Application Priority Data
Apr. 11, 2023 (CN) 202310382420.X

(51) Int. Cl. G06F 16/955

(52) U.S. Cl. CPC G06F 16/9566

(57) ABSTRACT

Embodiments of the present disclosure provide a link redirection method and device, and a storage medium. The method includes: determining, based on a short link to be accessed of a target application, a preset redirection rule corresponding to the short link to be accessed, where the preset redirection rule includes a plurality of different long links corresponding to the short link to be accessed and mapping conditions corresponding to the plurality of different long links; determining a currently satisfied target mapping condition from the mapping conditions corresponding to the plurality of different long links; and mapping the short link to be accessed to a long link corresponding to the target mapping condition.

### CROSS-REFERENCE TO RELATED APPLICATION(S)

The present application is a U.S. National Stage application under 35 U.S.C. § 371 of International Application No. PCT/CN2024/086843, as filed on Apr. 9, 2024, which is based on and claims priority to Chinese patent application No. 202310382420.X, filed on Apr. 11, 2023, titled “LINK REDIRECT METHODS, DEVICE AND STORAGE MEDIUM”, the disclosures of the applications are incorporated herein by reference in their entireties.

### TECHNICAL FIELD

Embodiments of the present disclosure relate to the field of computer and network communication technologies, and in particular, to a link redirection method and device, and a storage medium.

### BACKGROUND

In scenarios such as resource promotion, it is often necessary to deploy specific links at designated resource positions to achieve promotion. The existing solutions are costly and cannot meet the timeliness requirement.

### SUMMARY

Embodiments of the present disclosure provide a link redirection method and device, and a storage medium.

According to a first aspect, an embodiment of the present disclosure provides a link redirection method. The method includes:
determining, based on a short link to be accessed of a target application, a preset redirection rule corresponding to the short link to be accessed, where the preset redirection rule includes a plurality of different long links corresponding to the short link to be accessed and mapping conditions corresponding to the plurality of different long links;
determining a currently satisfied target mapping condition from the mapping conditions corresponding to the plurality of different long links; and
mapping the short link to be accessed to a long link corresponding to the target mapping condition.

According to a second aspect, an embodiment of the present disclosure provides a link redirection method. The method includes:
receiving a short link generation instruction for a target application, where the short link generation instruction includes a plurality of different long links corresponding to a target short link to be generated and mapping conditions corresponding to the plurality of different long links;
generating the target short link for the plurality of different long links; and
generating a redirection rule corresponding to the target short link based on the plurality of different long links corresponding to the target short link and the mapping conditions corresponding to the plurality of different long links, and delivering the redirection rule to a client corresponding to the target application.

According to a third aspect, an embodiment of the present disclosure provides a link redirection device. The device includes:
a query unit configured to determine, based on a short link to be accessed of a target application, a preset redirection rule corresponding to the short link to be accessed, where the preset redirection rule includes a plurality of different long links corresponding to the short link to be accessed and mapping conditions corresponding to the plurality of different long links;
a determination unit configured to determine a currently satisfied target mapping condition from the mapping conditions corresponding to the plurality of different long links; and
a mapping unit configured to map the short link to be accessed to a long link corresponding to the target mapping condition.

According to a fourth aspect, an embodiment of the present disclosure provides a link redirection device. The device includes:
an input unit configured to receive a short link generation instruction for a target application, where the short link generation instruction includes a plurality of different long links corresponding to a target short link to be generated and mapping conditions corresponding to the plurality of different long links;
a generation unit configured to generate the target short link for the plurality of different long links, and generate a redirection rule corresponding to the target short link based on the plurality of different long links corresponding to the target short link and the mapping conditions corresponding to the plurality of different long links; and
a delivery unit configured to deliver the redirection rule to a client corresponding to the target application.

According to a fifth aspect, an embodiment of the present disclosure provides an electronic device. The electronic device includes: at least one processor and a memory, where
the memory stores computer-executable instructions; and
the at least one processor executes the computer-executable instructions stored in the memory, to cause the at least one processor to perform the link redirection method according to the first aspect and various possible designs of the first aspect or the link redirection method according to the second aspect and various possible designs of the second aspect.

According to a sixth aspect, an embodiment of the present disclosure provides a computer-readable storage medium. The computer-readable storage medium has stored therein computer-executable instructions that, when executed by a processor, cause the link redirection method according to the first aspect and various possible designs of the first aspect or the link redirection method according to the second aspect and various possible designs of the second aspect to be implemented.

According to a seventh aspect, an embodiment of the present disclosure provides a computer program product. The computer program product includes computer-executable instructions that, when executed by a processor, cause the link redirection method according to the first aspect and various possible designs of the first aspect or the link redirection method according to the second aspect and various possible designs of the second aspect to be implemented.

According to an eighth aspect, an embodiment of the present disclosure provides a computer program. The computer program includes computer-executable instructions that, when executed by a processor, cause the link redirection method according to the first aspect and various possible designs of the first aspect or the link redirection method according to the second aspect and various possible designs of the second aspect to be implemented.

### BRIEF DESCRIPTION OF THE DRAWINGS

In order to describe the technical solutions in embodiments of the present disclosure or in the related art more clearly, the accompanying drawings for describing the embodiments or the related art will be briefly described below. Apparently, the accompanying drawings in the description below show some embodiments of the present disclosure, and those of ordinary skill in the art may still derive other accompanying drawings from these accompanying drawings without creative efforts.

FIG. 1 is a schematic flowchart of a link redirection method according to an embodiment of the present disclosure;

FIG. 2 is a schematic flowchart of a link redirection method according to another embodiment of the present disclosure;

FIG. 3 is a schematic flowchart of a link redirection method according to another embodiment of the present disclosure;

FIG. 4 is a block diagram of a structure of a link redirection device according to an embodiment of the present disclosure;

FIG. 5 is a block diagram of a structure of a link redirection device according to another embodiment of the present disclosure; and

FIG. 6 is a schematic diagram of a hardware structure of an electronic device according to an embodiment of the present disclosure.

### DETAILED DESCRIPTION

In order to make the objectives, technical solutions, and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

In scenarios such as resource promotion, it is often necessary to deploy specific links (e.g., URL schemes) at designated resource positions to achieve promotion.

In a process of accessing a page through a conventional URL scheme, after a user clicks on a URL scheme on a terminal device, a target application to which the URL scheme belongs is determined, and then it is determined whether the terminal device is currently in the target application. If it is determined that the terminal device is not currently in the target application, the target application is started, and then, the target application opens the corresponding page based on the URL scheme. If it is determined that the terminal device is currently in the target application, the target application directly opens the corresponding page based on the URL scheme.

In the case of large-scale promotion of resources, URL scheme links of the promoted resources often need to be widely deployed on the Internet. However, if the URL scheme needs to be changed in a later stage, the cost will be relatively high, and the timeliness requirement may not be met.

In order to solve the above technical problem, the present disclosure provides a link redirection method which aims to enable the same short link to be mapped to different long links under different mapping conditions during a redirection process. In application scenarios such as resource (e.g., event pages) promotion, only one short link needs to be deployed at a resource position. When the long link to be promoted changes, the short link deployed at the resource position does not need to be modified, thereby reducing the cost. Specifically, the link redirection method includes: determining, based on a short link to be accessed of a target application, a preset redirection rule corresponding to the short link to be accessed, where the preset redirection rule includes a plurality of different long links corresponding to the short link to be accessed and mapping conditions corresponding to the plurality of different long links; determining a currently satisfied target mapping condition from the mapping conditions corresponding to the plurality of different long links; and mapping the short link to be accessed to a long link corresponding to the target mapping condition.

In a process of accessing a page through a URL scheme of a short link of the present disclosure, after a user clicks on a URL scheme of a short link on a terminal device, a target application to which the URL scheme of the short link belongs is determined, and then whether it is currently in the target application is determined. If it is determined that it is not currently in the target application, the target application is started, and then the target application performs the above link redirection method to obtain a URL scheme of a long link corresponding to the URL scheme of the short link, and opens the corresponding page based on the URL scheme of the long link. If it is determined that it is currently in the target application, the target application directly performs the above link redirection method to obtain the URL scheme of the long link corresponding to the URL scheme of the short link, and opens the corresponding page based on the URL scheme of the long link.

Embodiments of the present disclosure provide a link redirection method and device, and a storage medium to enable the same short link to be mapped to different long links under different mapping conditions, thereby reducing the cost of resource promotion.

It should be noted that user information (including but not limited to device information, personal information, etc., of a user) and data (including but not limited to data for analysis, stored data, displayed data, etc.) involved in the present disclosure are information and data for which an authorization is obtained from the user or a full authorization is obtained from each party, and the collection, use, and processing of relevant data need to comply with relevant laws, regulations, and standards of relevant countries and regions, for which corresponding operation entries are provided for the user to choose to authorize or deny.

The link redirection method in the present disclosure is described in detail below with reference to specific embodiments.

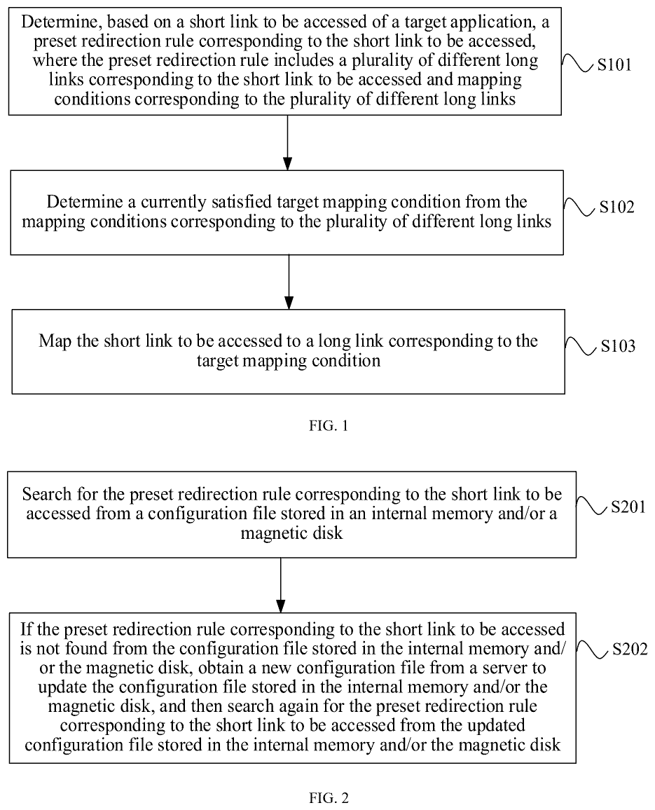

Referring to FIG. 1, FIG. 1 is a schematic flowchart of a link redirection method according to an embodiment of the present disclosure. The method of this embodiment may be applied to a terminal device. The link redirection method includes the following steps.

S101. Determine, based on a short link to be accessed of a target application, a preset redirection rule corresponding to the short link to be accessed, where the preset redirection rule includes a plurality of different long links corresponding to the short link to be accessed and mapping conditions corresponding to the plurality of different long links.

In this embodiment, a preset redirection rule may be pre-configured for any short link of the target application, where the preset redirection rule is a mapping rule between a short link and a long link. In this embodiment, the same short link may be mapped to different long links under different mapping conditions, that is, the short link and the long link are in a one-to-many mapping relationship. In this way, in an application scenario of resource promotion, if a long link for accessing a resource to be promoted changes, the long link may still correspond to the same short link, that is, the short link does not need to be modified, but only the long link and the corresponding mapping condition need to be modified (or added) in the preset redirection rule corresponding to the short link. The mapping conditions include, but are not limited to, attribute conditions of the target application and/or time conditions, that is, the same short link may be mapped to different long links under different attribute conditions and/or different time conditions, where attributes include, but are not limited to, version information of the target application.

In some embodiments, a plurality of different long links corresponding to a short link to be accessed are used to access different resources to be promoted, and the resources to be promoted may be different under different mapping conditions, that is, the mapping conditions corresponding to the plurality of different long links for the plurality of different resources to be promoted are different. Certainly, it may also be that the resources to be promoted are not changed, there are a plurality of long links for accessing the resources to be promoted, and the mapping conditions corresponding to the plurality of different long links of the same resource to be promoted are different.

In some embodiments, the preset redirection rule corresponding to any short link of the target application may be recorded in a configuration file of the target application. For any short link to be accessed, the corresponding preset redirection rule may be searched for from the configuration file.

S102. Determine a currently satisfied target mapping condition from the mapping conditions corresponding to the plurality of different long links.

In this embodiment, since the short link to be accessed corresponds to a plurality of different long links under different mapping conditions in the preset redirection rule of the short link to be accessed, it is necessary to determine which mapping condition is currently satisfied, and the satisfied mapping condition is the target mapping condition.

For example, if any one of the mapping conditions corresponding to the plurality of different long links includes an attribute condition of the target application and/or a time condition, whether current attribute information of the target application and/or current time satisfies any one of the different mapping conditions may be determined; and if any one of the mapping conditions is satisfied, the mapping condition is determined as the target mapping condition.

S103. Map the short link to be accessed to a long link corresponding to the target mapping condition.

In this embodiment, after the currently satisfied target mapping condition is determined, a long link corresponding to the target mapping condition may be determined from the preset redirection rule corresponding to the short link to be accessed, and then the short link to be accessed is mapped to the long link corresponding to the target mapping condition. The target application may jump to the corresponding page based on the long link after mapping.

In the link redirection method provided in this embodiment, the preset redirection rule corresponding to the short link to be accessed of the target application is determined according to the short link to be accessed, where the preset redirection rule includes a plurality of different long links corresponding to the short link to be accessed and mapping conditions corresponding to the plurality of different long links; the currently satisfied target mapping condition is determined from the mapping conditions corresponding to the plurality of different long links; and the short link to be accessed is mapped to a long link corresponding to the target mapping condition. Through a redirection process, the same short link can be mapped to different long links under different mapping conditions. In application scenarios such as resource promotion, only one short link needs to be deployed at a resource position. When the long link to be promoted changes, the short link deployed at the resource position does not need to be modified, thereby reducing the cost.

In some embodiments, the link redirection method of this embodiment may be applied to a case of accessing a short link to be accessed. Before the determining, based on the short link to be accessed of the target application, the preset redirection rule corresponding to the short link to be accessed, the method may further include: parsing the short link to be accessed, and determining the target application accessed by the short link to be accessed; determining whether it is currently in the target application, starting the target application if it is determined that it is not currently in the target application, and then, performing S101 to S103 above; and directly performing S101 to S103 above if it is determined that it is currently in the target application.

On the basis of any one of the above embodiments, the preset redirection rule corresponding to any short link of the target application may be recorded in the configuration file of the target application. In order to facilitate the generation of the short link and the search of the preset redirection rule, in this embodiment, identification information of a page is defined in the short link, and then a correspondence between the identification information of the page and the preset redirection rule corresponding to the short link is established in the configuration file of the target application. The preset redirection rule corresponding to the short link is searched for from the configuration file based on the identification information of the page included in the short link.

More specifically, a short link format in this embodiment is defined as follows:
H://short_link?page_key=xxx,
where H is a universal identifier (i.e., protocol name scheme) of each application, which is defined here as H for the convenience of expression;
short_link is a domain name (host) of the protocol, which may be defined by a developer and is defined here as short_link for the convenience of expression; and
page_key=xxx is identification information of a page for identifying a particular page, where “xxx” may be replaced with identification information of a specific page in actual situations. In some embodiments, a keyword of a query parameter in a long link may be used. For example, identification information of a homepage of a card collection activity of the Spring Festival may be defined as page_key=2023_cny_homepage.

Further, the preset redirection rule corresponding to any short link of the target application is recorded in the configuration file of the target application. The configuration file of the target application may include preset redirection rules corresponding to one or more short links, such as a preset redirection rule of a short link H://short_link?page_key=page_a (page is identified with page_key=page_a), and a preset redirection rule of a short link H://short_link?page_key=page_b (page is identified with page_key=page_b).

Based on the configuration file of the target application, if the short link to be accessed is:
H://short_link?page_key=page_b,
the short link to be accessed is parsed to obtain identification information of a page to be accessed included in the short link to be accessed: “page_key=page_b”; and the preset redirection rule corresponding to the short link to be accessed is searched for from the configuration file of the target application based on the identification information of the page to be accessed. The preset redirection rule found may be as follows:
when a version of the target application is later than x and a time stamp of the current time is greater than 1675069232, the corresponding long link is “H://lynxview?url=a”; and when the version of the target application is earlier than x, the corresponding long link is “H://webview?url=c”.

It should be noted that the configuration file of the target application may also include a case where one short link corresponds to one long link. For example, for a short link:
H://short_link?page_key=2023_cny_homepage,
in the configuration file of the target application, based on the identification information “page_key=2023_cny_homepage” of a page corresponding to the short link, the preset redirection rule corresponding to the short link may be found as:
“2023_cny_homepage”: “H://lynxview?url=xx”.

It can be seen that the short link only corresponds to one long link “H://lynxview?url=xx”.

On the basis of any one of the above embodiments, the mapping conditions corresponding to a plurality of different long links corresponding to a short link to be accessed may be mutually exclusive, that is, if one of the mapping conditions is currently satisfied, it is impossible to simultaneously satisfy the other mapping conditions. Alternatively, the mapping conditions corresponding to a plurality of different long links corresponding to a short link to be accessed may not be mutually exclusive, but the mapping conditions corresponding to the plurality of different long links have a priority order. When a currently satisfied target mapping condition is determined from the mapping conditions corresponding to the plurality of different long links, the currently satisfied target mapping condition may be determined from the mapping conditions corresponding to the plurality of different long links based on priorities of the mapping conditions corresponding to the plurality of different long links. If it is determined that a high-priority mapping condition is currently satisfied, there is no need to determine the low-priority mapping conditions subsequently, and the high-priority mapping condition is directly used as the target mapping condition.

On the basis of any one of the above embodiments, when a currently satisfied target mapping condition is determined from the mapping conditions corresponding to the plurality of different long links, if it is determined that none of the mapping conditions corresponding to the plurality of different long links is currently satisfied, it is determined that a redirection has failed, a preset page (such as a homepage of the target application) or prompt information may be displayed, to prompt a user when the redirection fails.

On the basis of any one of the above embodiments, as shown in FIG. 2, when the determining, based on the short link to be accessed of the target application, the preset redirection rule corresponding to the short link to be accessed, the method may include the following steps.

S201. Search for the preset redirection rule corresponding to the short link to be accessed from a configuration file stored in an internal memory and/or a magnetic disk.

S202. If the preset redirection rule corresponding to the short link to be accessed is not found from the configuration file stored in the internal memory and/or the magnetic disk, obtain a new configuration file from a server to update the configuration file stored in the internal memory and/or the magnetic disk, and then search again for the preset redirection rule corresponding to the short link to be accessed from the updated configuration file stored in the internal memory and/or the magnetic disk.

In this embodiment, the configuration file of the target application may be pulled from the server after a cold start of the target application and written in a local internal memory and/or a magnetic disk of the client. Further, for the short link to be accessed, the preset redirection rule corresponding to the short link to be accessed may be searched for from the configuration file stored in the internal memory and/or the magnetic disk. In some embodiments, the magnetic disk may store the full configuration file (including preset redirection rules corresponding to all short links) of the target application, and the internal memory may store part of the configuration file of the target application (including preset redirection rules corresponding to some short links). The preset redirection rule corresponding to the short link to be accessed may first be searched for from the configuration file stored in the internal memory. If it is not found, the preset redirection rule corresponding to the short link to be accessed may be searched for from the configuration file stored in the magnetic disk, thereby effectively improving the query speed.

Since the configuration file of the target application of the server may be updated, there may be a case where the preset redirection rule corresponding to the short link to be accessed is not found from the configuration file stored in the internal memory and/or the magnetic disk. Therefore, a new configuration file may be obtained from the server to update the configuration file stored in the internal memory and/or the magnetic disk, and then the preset redirection rule corresponding to the short link to be accessed is searched again for from the updated configuration file stored in the internal memory and/or the magnetic disk, so as to ensure the effectiveness of the found preset redirection rule corresponding to the short link to be accessed, thereby ensuring successful link redirection.

In addition, a new configuration file may also be obtained from the server at preset intervals to update the configuration file stored in the internal memory and/or the magnetic disk. By polling, it is ensured that the configuration file stored in the internal memory and/or the magnetic disk is the latest configuration file. For example, the configuration file is updated every 3000 seconds.

In some embodiments, the server in this embodiment may be a content delivery network (CDN) server. A terminal device may send a configuration file obtaining request to the CDN server, and receive a new configuration file returned by the CDN server. The CDN server adopts distributed storage, can undertake high traffic access with high access speed, low cost and good stability, and can support a polling process. Using a conventional service API requires solving problems of stability and access speed of high traffic, and polling consumes a lot of service resources and has high cost.

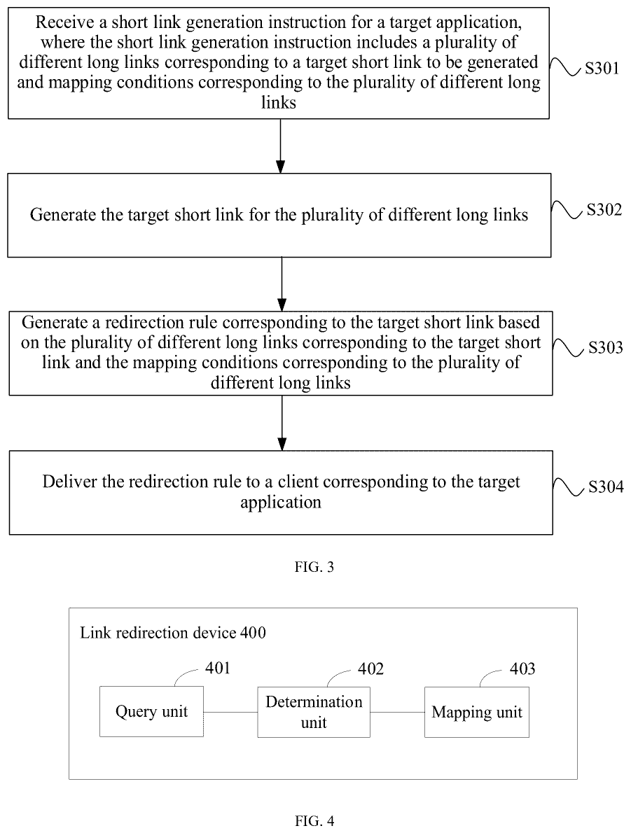

Referring to FIG. 3, FIG. 3 is a schematic flowchart of a link redirection method according to an embodiment of the present disclosure. The method of this embodiment is a method for generating short links and a corresponding redirection rule, which may be applied to a server. The link redirection method includes the following steps.

S301. Receive a short link generation instruction for a target application, where the short link generation instruction includes a plurality of different long links corresponding to a target short link to be generated and mapping conditions corresponding to the plurality of different long links.

In this embodiment, a user may apply for a short link to the target application, the server may provide the user with a visual entering and editing interface (such as a form-like input interface), and the user may input a plurality of different long links corresponding to a target short link to be generated and mapping conditions corresponding to the plurality of different long links (for example, input attributes of the application, time information, etc.) through the interface, thereby issuing a short link generation instruction to the server.

S302. Generate the target short link for the plurality of different long links.

In this embodiment, for a preset short link format, reference may be made to the example in the above embodiment.

The short link generation instruction includes identification information of a page corresponding to the target short link. The identification information of the page may be a keyword of a query parameter in a long link. Certainly, the identification information of the page may also be other characters, for example, may be generated randomly or according to specific rules, or set by the user. Further, the target short link may be generated for the plurality of different long links based on the identification information of the page and the preset short link format, so that the target short link includes the identification information of the page.

S303. Generate a redirection rule corresponding to the target short link based on the plurality of different long links corresponding to the target short link and the mapping conditions corresponding to the plurality of different long links.

In this embodiment, after the plurality of different long links corresponding to the target short link and the mapping conditions corresponding to the plurality of different long links are obtained, a redirection rule corresponding to a short link to be edited shown in the above example may be generated.

S304. Deliver the redirection rule to a client corresponding to the target application.

In this embodiment, for the delivery of the redirection rule, the server may push the redirection rule to the client (the terminal device installed with the target application) corresponding to the target application, or may send the redirection rule to the client when the client pulls the redirection rule.

In some embodiments, the redirection rule corresponding to the target short link may be delivered in the form of a configuration file.

In some embodiments, the redirection rule may be delivered to the client corresponding to the target application through the CDN server. The CDN server adopts distributed storage, and can undertake high traffic access with high access speed, low cost and good stability.

Specifically, the server may first write the redirection rule in a database, and then send the redirection rule to the CDN server.

Further, when the terminal device determines, based on, the short link to be accessed of the target application, the preset redirection rule corresponding to the short link to be accessed, if the preset redirection rule corresponding to the short link to be accessed is not found from a configuration file stored in an internal memory and/or a magnetic disk, a new configuration file is requested from the CDN server, and the CDN server queries whether the configuration file stored in the CDN server includes the preset redirection rule corresponding to the short link to be accessed. If the configuration file stored in the CDN server includes the preset redirection rule corresponding to the short link to be accessed, the configuration file is sent to the terminal device to update the configuration file stored in the internal memory and/or the magnetic disk of the terminal device, and the terminal device searches again for the preset redirection rule corresponding to the short link to be accessed from the updated configuration file stored in the internal memory and/or the magnetic disk. If the configuration file stored in the CDN server does not include the preset redirection rule corresponding to the short link to be accessed, a new configuration file is requested from the database, the new configuration file is sent to the terminal device to update the configuration file stored in the internal memory and/or the magnetic disk of the terminal device, and the terminal device searches again for the preset redirection rule corresponding to the short link to be accessed from the updated configuration file stored in the internal memory and/or the magnetic disk.

On the basis of any one of the above embodiments, before the generating the target short link for the plurality of different long links, the method further includes:
detecting the plurality of different long links corresponding to the target short link and/or the mapping conditions corresponding to the plurality of different long links; and displaying error prompt information if the detection fails.

In this embodiment, after the plurality of different long links corresponding to the target short link to be generated and the mapping conditions corresponding to the plurality of different long links included in the short link generation instruction are obtained, the plurality of different long links corresponding to the target short link and/or the mapping conditions corresponding to the plurality of different long links may be detected, including but not limited to determining whether attribute information and time information are accurate, determining whether the mapping conditions corresponding to the plurality of different long links conflict, determining whether the identification information of the page corresponding to the target short link is duplicated with identification information of a page corresponding to another short link, etc. When the detection fails, the user may be prompted to make modifications. When the detection succeeds, subsequent steps may be performed.

Corresponding to the link redirection method of the above embodiment, FIG. 4 is a block diagram of a structure of a link redirection device according to an embodiment of the present disclosure. The device may be configured to perform the above link redirection method at a terminal device side. For ease of illustration, only parts related to this embodiment of the present disclosure are shown. Referring to FIG. 4, the link redirection device 400 includes: a query unit 401, a determination unit 402, and a mapping unit 403.

The query unit 401 is configured to determine, based on a short link to be accessed of a target application, a preset redirection rule corresponding to the short link to be accessed, where the preset redirection rule includes a plurality of different long links corresponding to the short link to be accessed and mapping conditions corresponding to the plurality of different long links.

The determination unit 402 is configured to determine a currently satisfied target mapping condition from the mapping conditions corresponding to the plurality of different long links.

The mapping unit 403 is configured to map the short link to be accessed to a long link corresponding to the target mapping condition.

In one or more embodiments of the present disclosure, the plurality of different long links corresponding to the short link to be accessed are configured to access a plurality of different resources to be promoted, and the mapping conditions corresponding to the plurality of different long links for the plurality of different resources to be promoted are different; or
the plurality of different long links corresponding to the short link to be accessed are configured to access the same resource to be promoted, and the mapping conditions corresponding to the plurality of different long links of the same resource to be promoted are different.

In one or more embodiments of the present disclosure, when determining, based on the short link to be accessed of the target application, the preset redirection rule corresponding to the short link to be accessed, the query unit 401 is configured to:
parse the short link to be accessed to obtain identification information of a page to be accessed included in the short link to be accessed; and
search for the preset redirection rule corresponding to the short link to be accessed from a configuration file of the target application based on the identification information of the page to be accessed, where the configuration file includes preset redirection rules corresponding to identification information of different preset pages.

In one or more embodiments of the present disclosure, any one of the mapping conditions corresponding to the plurality of different long links includes an attribute condition of the target application and/or a time condition.

When determining the currently satisfied target mapping condition from the mapping conditions corresponding to the plurality of different long links, the determination unit 402 is configured to:
determine whether current attribute information of the target application and/or current time satisfies any one of the different mapping conditions; and
if any one of the mapping conditions is satisfied, determine the mapping condition as the target mapping condition.

In one or more embodiments of the present disclosure, when determining the currently satisfied target mapping condition from the mapping conditions corresponding to the plurality of different long links, the determination unit 402 is configured to:
determine the currently satisfied target mapping condition from the mapping conditions corresponding to the plurality of different long links based on priorities of the mapping conditions corresponding to the plurality of different long links.

In one or more embodiments of the present disclosure, the determination unit 402 is further configured to:
if it is determined that none of the mapping conditions corresponding to the plurality of different long links is currently satisfied, determine that a redirection has failed, and display a preset page or prompt information.

In one or more embodiments of the present disclosure, the determination unit 402 is further configured to: before the determining, based on the short link to be accessed of the target application, the preset redirection rule corresponding to the short link to be accessed, parse the short link to be accessed and determine the target application accessed by the short link to be accessed; and determine whether it is currently in the target application, and start the target application if it is determined that it is not currently in the target application.

In one or more embodiments of the present disclosure, when determining, based on the short link to be accessed of the target application, the preset redirection rule corresponding to the short link to be accessed, the query unit 401 is configured to:
search for the preset redirection rule corresponding to the short link to be accessed from a configuration file stored in an internal memory and/or a magnetic disk; and
if the preset redirection rule corresponding to the short link to be accessed is not found from the configuration file stored in the internal memory and/or the magnetic disk, obtain a new configuration file from a server to update the configuration file stored in the internal memory and/or the magnetic disk, and then search again for the preset redirection rule corresponding to the short link to be accessed from the updated configuration file stored in the internal memory and/or the magnetic disk.

In one or more embodiments of the present disclosure, the query unit 401 is further configured to:
obtain a new configuration file from the server at preset intervals to update the configuration file stored in a local internal memory and/or a magnetic disk.

In one or more embodiments of the present disclosure, the server is a content delivery network (CDN) server. When obtaining a new configuration file from the server, the query unit 401 is configured to:
send a configuration file obtaining request to the CDN server, and receive a new configuration file returned by the CDN server.

The device provided in this embodiment may be configured to perform the technical solutions of the above method embodiment at the terminal device side with the similar implementation principle and technical effects, and are not described herein again in this embodiment.

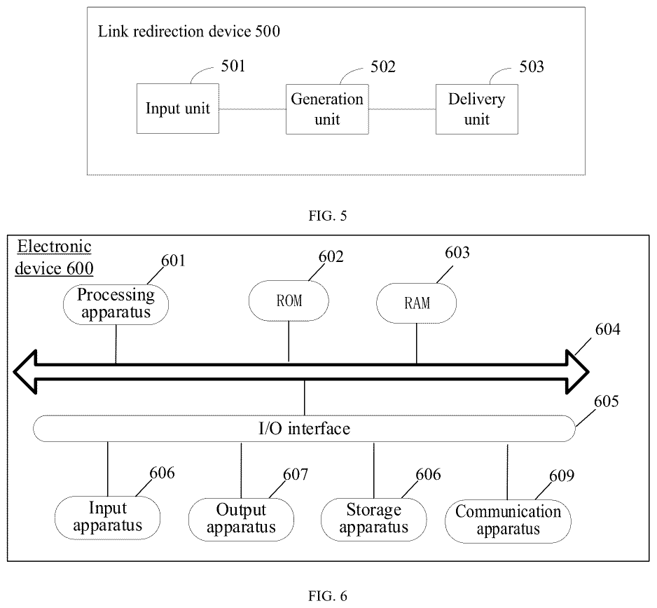

Corresponding to the link redirection method of the above embodiment, FIG. 5 is a block diagram of a structure of a link redirection device according to an embodiment of the present disclosure. The device may be configured to perform the above link redirection method at the server side. For ease of illustration, only parts related to this embodiment of the present disclosure are shown. Referring to FIG. 5, the link redirection device 500 includes: an input unit 501, a generation unit 502, and a delivery unit 503.

The input unit 501 is configured to receive a short link generation instruction for a target application, where the short link generation instruction includes a plurality of different long links corresponding to a target short link to be generated and mapping conditions corresponding to the plurality of different long links.

The generation unit 502 is configured to generate the target short link for the plurality of different long links, and generate a redirection rule corresponding to the target short link based on the plurality of different long links corresponding to the target short link and the mapping conditions corresponding to the plurality of different long links.

The delivery unit 503 is configured to deliver the redirection rule to a client corresponding to the target application.

In one or more embodiments of the present disclosure, the short link generation instruction further includes identification information of a page corresponding to the target short link.

When generating the target short link for the plurality of different long links, the generation unit 502 is configured to:
generate the target short link for the plurality of different long links based on the identification information of the page and a preset short link format such that the target short link includes the identification information of the page.

In one or more embodiments of the present disclosure, when delivering the redirection rule to the client corresponding to the target application, the delivery unit 503 is configured to:
deliver the redirection rule to the client corresponding to the target application through a CDN server.

In one or more embodiments of the present disclosure, the input unit 501 is further configured to:
detect the plurality of different long links corresponding to the target short link and/or the mapping conditions corresponding to the plurality of different long links; and
display error prompt information if the detection fails.

The device provided in this embodiment may be configured to perform the technical solutions of the above method embodiment at the server side with similar implementation principle and technical effects, and are not described herein again in this embodiment.

FIG. 6 shows a schematic diagram of a structure of an electronic device 600 suitable for implementing the embodiments of the present disclosure. The electronic device 600 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (such as a central processing unit or a graphics processing unit) 601 that may perform various appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to one another through a bus 604. An input/output (I/O) interface 605 is also connected to the bus 604.

Generally, the following apparatuses may be connected to the I/O interface 605: an input apparatus 606 including, for example, a touch screen, a touch pad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a magnetic tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 609, installed from the storage apparatus 608, or installed from the ROM 602. When the computer program is executed by the processing apparatus 601, the above functions defined in any method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The computer-readable medium carries one or more programs. When the above one or more programs are executed by the electronic device, the electronic device performs the method shown in any one of the above embodiments.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof.

According to a first aspect, according to one or more embodiments of the present disclosure, a link redirection method is provided. The method includes:
determining, based on a short link to be accessed of a target application, a preset redirection rule corresponding to the short link to be accessed, where the preset redirection rule includes a plurality of different long links corresponding to the short link to be accessed and mapping conditions corresponding to the plurality of different long links;
determining a currently satisfied target mapping condition from the mapping conditions corresponding to the plurality of different long links; and
mapping the short link to be accessed to a long link corresponding to the target mapping condition.

According to one or more embodiments of the present disclosure, the plurality of different long links corresponding to the short link to be accessed are configured to access a plurality of different resources to be promoted, and the mapping conditions corresponding to the plurality of different long links for the plurality of different resources to be promoted are different; or
the plurality of different long links corresponding to the short link to be accessed are configured to access the same resource to be promoted, and the mapping conditions corresponding to the plurality of different long links of the same resource to be promoted are different.

According to one or more embodiments of the present disclosure, the determining, based on the short link to be accessed of the target application, the preset redirection rule corresponding to the short link to be accessed includes:
parsing the short link to be accessed to obtain identification information of a page to be accessed included in the short link to be accessed; and
searching for the preset redirection rule corresponding to the short link to be accessed from a configuration file of the target application based on the identification information of the page to be accessed, where the configuration file includes preset redirection rules corresponding to identification information of different preset pages.

According to one or more embodiments of the present disclosure, any one of the mapping conditions corresponding to the plurality of different long links includes an attribute condition of the target application and/or a time condition.

The determining the currently satisfied target mapping condition from the mapping conditions corresponding to the plurality of different long links includes:
determining whether current attribute information of the target application and/or current time satisfies any one of the different mapping conditions; and
if any one of the mapping conditions is satisfied, determining the mapping condition as the target mapping condition.

According to one or more embodiments of the present disclosure, the determining the currently satisfied target mapping condition from the mapping conditions corresponding to the plurality of different long links includes:
determining the currently satisfied target mapping condition from the mapping conditions corresponding to the plurality of different long links based on priorities of the mapping conditions corresponding to the plurality of different long links.

According to one or more embodiments of the present disclosure, the method further includes:
if it is determined that none of the mapping conditions corresponding to the plurality of different long links is currently satisfied, determining that a redirection has failed, and displaying a preset page or prompt information.

According to one or more embodiments of the present disclosure, before the determining, based on the short link to be accessed of the target application, the preset redirection rule corresponding to the short link to be accessed, the method further includes:
parsing the short link to be accessed, and determining the target application accessed by the short link to be accessed; and
determining whether it is currently in the target application, and starting the target application if it is determined that it is not currently in the target application.

According to one or more embodiments of the present disclosure, the determining, based on the short link to be accessed of the target application, the preset redirection rule corresponding to the short link to be accessed includes:
searching for the preset redirection rule corresponding to the short link to be accessed from a configuration file stored in an internal memory and/or a magnetic disk; and
if the preset redirection rule corresponding to the short link to be accessed is not found from the configuration file stored in the internal memory and/or the magnetic disk, obtaining a new configuration file from a server to update the configuration file stored in the internal memory and/or the magnetic disk, and then searching again for the preset redirection rule corresponding to the short link to be accessed from the updated configuration file stored in the internal memory and/or the magnetic disk.

According to one or more embodiments of the present disclosure, the method further includes:
obtaining a new configuration file from the server at preset intervals to update the configuration file stored in a local internal memory and/or a magnetic disk.

According to one or more embodiments of the present disclosure, the server is a content delivery network (CDN) server. The obtaining the new configuration file from the server includes:
sending a configuration file obtaining request to the CDN server, and receiving a new configuration file returned by the CDN server.

According to a second aspect, according to one or more embodiments of the present disclosure, a link redirection method is provided. The method includes:
receiving a short link generation instruction for a target application, where the short link generation instruction includes a plurality of different long links corresponding to a target short link to be generated and mapping conditions corresponding to the plurality of different long links;
generating the target short link for the plurality of different long links; and
generating a redirection rule corresponding to the target short link based on the plurality of different long links corresponding to the target short link and the mapping conditions corresponding to the plurality of different long links, and delivering the redirection rule to a client corresponding to the target application.

According to one or more embodiments of the present disclosure, the short link generation instruction further includes identification information of a page corresponding to the target short link.

The generating the target short link for the plurality of different long links includes:
generating the target short link for the plurality of different long links based on the identification information of the page and a preset short link format such that the target short link includes the identification information of the page.

According to one or more embodiments of the present disclosure, the delivering the redirection rule to the client corresponding to the target application includes:
delivering the redirection rule to the client corresponding to the target application through a CDN server.

According to one or more embodiments of the present disclosure, before the generating the target short link for the plurality of different long links, the method further includes:
detecting the plurality of different long links corresponding to the target short link and/or the mapping conditions corresponding to the plurality of different long links; and
displaying error prompt information if the detection fails.

According to a third aspect, according to one or more embodiments of the present disclosure, a link redirection device is provided. The device includes:
a query unit configured to determine, based on a short link to be accessed of a target application, a preset redirection rule corresponding to the short link to be accessed, where the preset redirection rule includes a plurality of different long links corresponding to the short link to be accessed and mapping conditions corresponding to the plurality of different long links;
a determination unit configured to determine a currently satisfied target mapping condition from the mapping conditions corresponding to the plurality of different long links; and
a mapping unit configured to map the short link to be accessed to a long link corresponding to the target mapping condition.

According to one or more embodiments of the present disclosure, the plurality of different long links corresponding to the short link to be accessed are configured to access a plurality of different resources to be promoted, and the mapping conditions corresponding to the plurality of different long links for the plurality of different resources to be promoted are different; or
the plurality of different long links corresponding to the short link to be accessed are configured to access the same resource to be promoted, and the mapping conditions corresponding to the plurality of different long links of the same resource to be promoted are different.

According to one or more embodiments of the present disclosure, when determining, based on the short link to be accessed of the target application, the preset redirection rule corresponding to the short link to be accessed, the query unit is configured to:
parse the short link to be accessed to obtain identification information of a page to be accessed included in the short link to be accessed; and
searching for the preset redirection rule corresponding to the short link to be accessed from a configuration file of the target application based on the identification information of the page to be accessed, where the configuration file includes preset redirection rules corresponding to identification information of different preset pages.

According to one or more embodiments of the present disclosure, any one of the mapping conditions corresponding to the plurality of different long links includes an attribute condition of the target application and/or a time condition.

When determining the currently satisfied target mapping condition from the mapping conditions corresponding to the plurality of different long links, the determination unit is configured to:
determine whether current attribute information of the target application and/or current time satisfies any one of the different mapping conditions; and
if any one of the mapping conditions is satisfied, determine the mapping condition as the target mapping condition.

According to one or more embodiments of the present disclosure, when determining the currently satisfied target mapping condition from the mapping conditions corresponding to the plurality of different long links, the determination unit is configured to:
determine the currently satisfied target mapping condition from the mapping conditions corresponding to the plurality of different long links based on priorities of the mapping conditions corresponding to the plurality of different long links.

According to one or more embodiments of the present disclosure, the determination unit is further configured to:
if it is determined that none of the mapping conditions corresponding to the plurality of different long links is currently satisfied, determine that a redirection has failed, and display a preset page or prompt information.

According to one or more embodiments of the present disclosure, before the determining, based on the short link to be accessed of the target application, the preset redirection rule corresponding to the short link to be accessed, the determination unit is further configured to parse the short link to be accessed, and determine the target application accessed by the short link to be accessed; and determine whether it is currently in the target application, and start the target application if it is determined that it is not currently in the target application.

According to one or more embodiments of the present disclosure, when determining, based on the short link to be accessed of the target application, the preset redirection rule corresponding to the short link to be accessed, the query unit is configured to:
search for the preset redirection rule corresponding to the short link to be accessed from a configuration file stored in an internal memory and/or a magnetic disk; and
if the preset redirection rule corresponding to the short link to be accessed is not found from the configuration file stored in the internal memory and/or the magnetic disk, obtain a new configuration file from a server to update the configuration file stored in the internal memory and/or the magnetic disk, and then search again for the preset redirection rule corresponding to the short link to be accessed from the updated configuration file stored in the internal memory and/or the magnetic disk.

According to one or more embodiments of the present disclosure, the query unit is further configured to:
obtain a new configuration file from the server at preset intervals to update the configuration file stored in a local internal memory and/or a magnetic disk.

According to one or more embodiments of the present disclosure, the server is a content delivery network (CDN) server. When obtaining the new configuration file from the server, the query unit is configured to:
send a configuration file obtaining request to the CDN server, and receive a new configuration file returned by the CDN server.

According to a fourth aspect, according to one or more embodiments of the present disclosure, a link redirection device is provided. The device includes:
an input unit configured to receive a short link generation instruction for a target application, where the short link generation instruction includes a plurality of different long links corresponding to a target short link to be generated and mapping conditions corresponding to the plurality of different long links;
a generation unit configured to generate the target short link for the plurality of different long links, and generate a redirection rule corresponding to the target short link based on the plurality of different long links corresponding to the target short link and the mapping conditions corresponding to the plurality of different long links; and
a delivery unit configured to deliver the redirection rule to a client corresponding to the target application.

According to one or more embodiments of the present disclosure, the short link generation instruction further includes identification information of a page corresponding to the target short link.

When generating the target short link for the plurality of different long links, the generation unit is configured to:
generate the target short link for the plurality of different long links based on the identification information of the page and a preset short link format such that the target short link includes the identification information of the page.

According to one or more embodiments of the present disclosure, when delivering the redirection rule to the client corresponding to the target application, the delivery unit is configured to:
deliver the redirection rule to the client corresponding to the target application through a CDN server.

According to one or more embodiments of the present disclosure, the input unit is further configured to:
detect the plurality of different long links corresponding to the target short link and/or the mapping conditions corresponding to the plurality of different long links; and
display error prompt information if the detection fails.

According to a fifth aspect, according to one or more embodiments of the present disclosure, an electronic device is provided. The electronic device includes: at least one processor and a memory, where
the memory stores computer-executable instructions; and
the at least one processor executes the computer-executable instructions stored in the memory, to cause the at least one processor to perform the link redirection method according to the first aspect and various possible designs of the first aspect or the link redirection method according to the second aspect and various possible designs of the second aspect.

According to a sixth aspect, according to one or more embodiments of the present disclosure, a computer-readable storage medium is provided. The computer-readable storage medium has stored therein computer-executable instructions that, when executed by a processor, cause the link redirection method according to the first aspect and various possible designs of the first aspect, or the link redirection method according to the second aspect and various possible designs of the second aspect to be implemented.

According to a seventh aspect, according to one or more embodiments of the present disclosure, a computer program product is provided. The computer program product includes computer-executable instructions that, when executed by a processor, cause the link redirection method according to the first aspect and various possible designs of the first aspect or the link redirection method according to the second aspect and various possible designs of the second aspect to be implemented.

According to an eighth aspect, according to one or more embodiments of the present disclosure, a computer program is provided. The computer program includes computer-executable instructions that, when executed by a processor, cause the link redirection method according to the first aspect and various possible designs of the first aspect, or the link redirection method according to the second aspect and various possible designs of the second aspect to be implemented.

The foregoing descriptions are merely explanations of preferred embodiments of the present disclosure and the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A link redirection method, comprising:
determining, based on a short link to be accessed of a target application, a preset redirection rule corresponding to the short link to be accessed, wherein the preset redirection rule comprises a plurality of different long links corresponding to the short link to be accessed and mapping conditions corresponding to the plurality of different long links;
determining a currently satisfied target mapping condition from the mapping conditions corresponding to the plurality of different long links; and
mapping the short link to be accessed to a long link corresponding to the target mapping condition.

2. The method according to claim 1, wherein the plurality of different long links corresponding to the short link to be accessed are configured to access a plurality of different resources to be promoted, and the mapping conditions corresponding to the plurality of different long links for the plurality of different resources to be promoted are different; or
the plurality of different long links corresponding to the short link to be accessed are configured to access the same resource to be promoted, and the mapping conditions corresponding to the plurality of different long links for the same resource to be promoted are different.

3. The method according to claim 1, wherein the determining, based on the short link to be accessed of the target application, the preset redirection rule corresponding to the short link to be accessed comprises:
parsing the short link to be accessed to obtain identification information of a page to be accessed comprised in the short link to be accessed; and
searching for the preset redirection rule corresponding to the short link to be accessed from a configuration file of the target application based on the identification information of the page to be accessed, wherein the configuration file comprises preset redirection rules corresponding to identification information of different preset pages.

4. The method according to claim 1, wherein any one of the mapping conditions corresponding to the plurality of different long links comprises at least one of an attribute condition of the target application or a time condition; and
the determining the currently satisfied target mapping condition from the mapping conditions corresponding to the plurality of different long links comprises:
determining whether at least one of current attribute information of the target application and/or current time satisfies any one of the different mapping conditions; and
in response to that any one of the mapping conditions is satisfied, determining the mapping condition as the target mapping condition.

5. The method according to claim 1, wherein the determining the currently satisfied target mapping condition from the mapping conditions corresponding to the plurality of different long links comprises:
determining the currently satisfied target mapping condition from the mapping conditions corresponding to the plurality of different long links based on priorities of the mapping conditions corresponding to the plurality of different long links.

6. The method according to claim 1, further comprising:
in response to determining that none of the mapping conditions corresponding to the plurality of different long links is currently satisfied, determining that a redirection has failed, and displaying a preset page or prompt information.

7. The method according to claim 1, wherein the determining, based on the short link to be accessed of the target application, the preset redirection rule corresponding to the short link to be accessed comprises:
searching for the preset redirection rule corresponding to the short link to be accessed from a configuration file stored in at least one of an internal memory or a magnetic disk; and
in response to that the preset redirection rule corresponding to the short link to be accessed is not found from the configuration file stored in at least one of the internal memory or the magnetic disk, obtaining a new configuration file from a server to update the configuration file stored in at least one of the internal memory or the magnetic disk, and then searching again for the preset redirection rule corresponding to the short link to be accessed from the updated configuration file stored in at least one of the internal memory or the magnetic disk.

8. The method according to claim 7, wherein the server is a content delivery network (CDN) server; and the obtaining the new configuration file from the server comprises:
sending a configuration file obtaining request to the CDN server, and receiving a new configuration file returned by the CDN server.

9. A link redirection method, comprising:
receiving a short link generation instruction for a target application, wherein the short link generation instruction comprises a plurality of different long links corresponding to a target short link to be generated and mapping conditions corresponding to the plurality of different long links;
generating the target short link for the plurality of different long links; and
generating a redirection rule corresponding to the target short link based on the plurality of different long links corresponding to the target short link and the mapping conditions corresponding to the plurality of different long links, and delivering the redirection rule to a client corresponding to the target application.

10. The method according to claim 9, wherein the short link generation instruction further comprises identification information of a page corresponding to the target short link; and
the generating the target short link for the plurality of different long links comprises:
generating the target short link for the plurality of different long links based on the identification information of the page and a preset short link format such that the target short link comprises the identification information of the page.

11-12. (canceled)

13. An electronic device, comprising: at least one processor and a memory, wherein
the memory stores computer-executable instructions; and
the at least one processor executes the computer-executable instructions stored in the memory, to cause the at least one processor to perform a link redirection method, comprising:
determining, based on a short link to be accessed of a target application, a preset redirection rule corresponding to the short link to be accessed, wherein the preset redirection rule comprises a plurality of different long links corresponding to the short link to be accessed and mapping conditions corresponding to the plurality of different long links;
determining a currently satisfied target mapping condition from the mapping conditions corresponding to the plurality of different long links; and
mapping the short link to be accessed to a long link corresponding to the target mapping condition.

14. A non-transitory computer-readable storage medium having stored therein computer-executable instructions that, when executed by a processor, cause the method according to claim 1 to be implemented.

15-16. (canceled)

17. The electronic device according to claim 13, wherein the plurality of different long links corresponding to the short link to be accessed are configured to access a plurality of different resources to be promoted, and the mapping conditions corresponding to the plurality of different long links for the plurality of different resources to be promoted are different; or
the plurality of different long links corresponding to the short link to be accessed are configured to access the same resource to be promoted, and the mapping conditions corresponding to the plurality of different long links for the same resource to be promoted are different.

18. The electronic device according to claim 13, wherein the determining, based on the short link to be accessed of the target application, the preset redirection rule corresponding to the short link to be accessed comprises:
parsing the short link to be accessed to obtain identification information of a page to be accessed comprised in the short link to be accessed; and
searching for the preset redirection rule corresponding to the short link to be accessed from a configuration file of the target application based on the identification information of the page to be accessed, wherein the configuration file comprises preset redirection rules corresponding to identification information of different preset pages.

19. The electronic device according to claim 13, wherein any one of the mapping conditions corresponding to the plurality of different long links comprises at least one of an attribute condition of the target application or a time condition; and
the determining the currently satisfied target mapping condition from the mapping conditions corresponding to the plurality of different long links comprises:
determining whether at least one of current attribute information of the target application or current time satisfies any one of the different mapping conditions; and
in response to that any one of the mapping conditions is satisfied, determining the mapping condition as the target mapping condition.

20. The electronic device according to claim 13, wherein the determining the currently satisfied target mapping condition from the mapping conditions corresponding to the plurality of different long links comprises:
determining the currently satisfied target mapping condition from the mapping conditions corresponding to the plurality of different long links based on priorities of the mapping conditions corresponding to the plurality of different long links.

21. The electronic device according to claim 13, further comprising:
in response to determining that none of the mapping conditions corresponding to the plurality of different long links is currently satisfied, determining that a redirection has failed, and displaying a preset page or prompt information.

22. The electronic device according to claim 13, wherein the determining, based on the short link to be accessed of the target application, the preset redirection rule corresponding to the short link to be accessed comprises:
searching for the preset redirection rule corresponding to the short link to be accessed from a configuration file stored in at least one of an internal memory or a magnetic disk; and
in response to that the preset redirection rule corresponding to the short link to be accessed is not found from the configuration file stored in at least one of the internal memory or the magnetic disk, obtaining a new configuration file from a server to update the configuration file stored in at least one of the internal memory or the magnetic disk, and then searching again for the preset redirection rule corresponding to the short link to be accessed from the updated configuration file stored in at least one of the internal memory or the magnetic disk.

23. An electronic device, comprising: at least one processor and a memory, wherein
the memory stores computer-executable instructions; and
the at least one processor executes the computer-executable instructions stored in the memory, to cause the at least one processor to perform the method according to claim 9.

24. A computer-readable storage medium having stored therein computer-executable instructions that, when executed by a processor, cause the method according to claim 9 to be implemented.
